(19) United States
(12) Patent Application Publication
(10) Pub. No.: US 2009/0249477 A1
(43) Pub. Date: Oct. 1, 2009

(54) METHOD AND SYSTEM FOR DETERMINING WHETHER A COMPUTER USER IS HUMAN

(75) Inventor: Kunal Punera, Mountain View, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/058,420

(22) Filed: Mar. 28, 2008

(51) Int. Cl. H04L 9/32

(52) U.S. Cl. 726/18

(57) ABSTRACT

A method and system for determining whether an online service user is human is provided. In one implementation, the method may include collecting personal information about the online service user, generating a question based on the personal information, communicating the question to the online service user in the form of a CAPTCHA, and receiving a response to the question presented in the CAPTCHA, wherein a correct response is interpreted to mean that the online service user is human. The method and system may also include measuring the response time in answering the question.

### BACKGROUND

1. Field of Invention

The present invention relates to computer systems that allow users to create accounts. Specifically, the present invention relates to a method and system for determining whether a user setting up an account is a computer or human.

2. Background Information

The growth of the internet has fueled a boom in web based applications. For example, commonly available applications include search engines, mapping tools, email websites, and message boards. Email websites and message boards offer an easy and cost effective way for individuals to communicate with one another. In many cases, these services are provided at no cost to the user. The user merely has to generate an account by providing information, such as a username, password and perhaps some personal information.

But along with the benefits of the enhanced communication has come the aggravation of junk mail or spam messages. A spam message typically includes unsolicited offers to sell some product or service. These messages can tend to clutter the inbox of an email account and lead to aggravation on the part of the owner of the email account. One way to minimize the aggravation caused by these messages may be to identify the spammer that sends a spam message and block any new spam messages from the spammer via a junk mail filter. However, many spammers have taken advantage of the easy account generation described above and developed automated systems for generating numerous email addresses. In many instances, simply changing the email address by one character may be sufficient to circumvent the junk mail filters described above.

One method utilized to prevent the abuse described above is to present a CAPTCHA (“Completely Automated Public Turing test to tell Computers and Humans Apart”) to the user attempting to create an account. The CAPTCHA may consist of a user challenge or image of several characters presented in a distorted fashion. The user may then be asked to solve the challenge or transcribe the text in the image. The CAPTCHA may be easily readable by a human, but not by a computer. CAPTCHA is a trademark of Carnegie Mellon University.

However, CAPTCHAs may be vulnerable to relay attacks that use humans to solve the user challenge presented in the CAPTCHA. In some cases, the CAPTCHA may be forwarded to a sweatshop of human operators who may be capable of solving the CAPTCHA. In other instances, the CAPTCHA may be solved by posting the CAPTCHA on a website offering free services and asking users to solve the user challenge presented. For example, the CAPTCHA may be utilized on a website offering pornography. Human users attempting to gain access to the website may be asked to solve the user challenge. Once solved, the answer may be utilized by an automated system attempting to generate, for example, an email account on an email server.

In an effort to limit the amount of spam an automated system may generate, some email systems may restrain the number of mail messages that can be sent by a user until the user becomes trusted. Once trusted, however, the restraints may be removed. To overcome these safeguards, some automated systems may behave as a normal user. For example, the automated system may only send a small number of emails to a limited number of email addresses at any given time. However, once the automated system becomes trusted and the restraints have been removed, these automated systems may attempt to send millions of spam messages.

### BRIEF SUMMARY

To address the problems outlined above, a method and system for determining whether an online service user is human is provided. In one implementation, the method may include collecting information about the online service user, generating a question based on the personal information, communicating the question to the online service user in the form of a CAPTCHA, and receiving a response to the question presented in the CAPTCHA, wherein a correct response is interpreted to mean that the online service user is human. The CAPTCHA may present the question in a distorted fashion so as to make it difficult for automated systems to read the question presented. The question may be based on personal information received during a registration process so as to make it impossible for another human unrelated to the online service user to know the correct answer. The method and system may also include measuring the response time in answering the question.

### BRIEF DESCRIPTION OF THE DRAWINGS

FIG. 1 is a diagram depicting a computer user communicating with a web server via an internet connection in the present invention;

FIG. 2a is a web page for entering registration information in connection with a first embodiment of the invention;

FIG. 2b is a first web page for logging into a user account in connection with the first embodiment of the invention;

FIG. 2c is a second web page for logging into a user account in connection with the first embodiment of the invention;

FIG. 3a is a first web page for logging into a user account in connection with a second embodiment of the invention;

FIG. 3b is a second web page for logging into a user account in connection with the second embodiment of the invention;

FIG. 4 is a flow diagram for verifying that a user is human in a first embodiment of the invention;

FIG. 5a is an exemplary text question distorted utilizing a first distortion method that may be utilized in connection with the present invention;

FIG. 5b is an exemplary text distorted utilizing a second distortion method that may be utilized in connection with the present invention;

FIG. 5c is an exemplary text distorted utilizing a third distortion method that may be utilized in connection with the present invention; and

FIG. 6 illustrates a general computer system, which may represent any of the computing devices referenced herein.

### DETAILED DESCRIPTION OF THE DRAWINGS AND THE PRESENTLY PREFERRED EMBODIMENTS

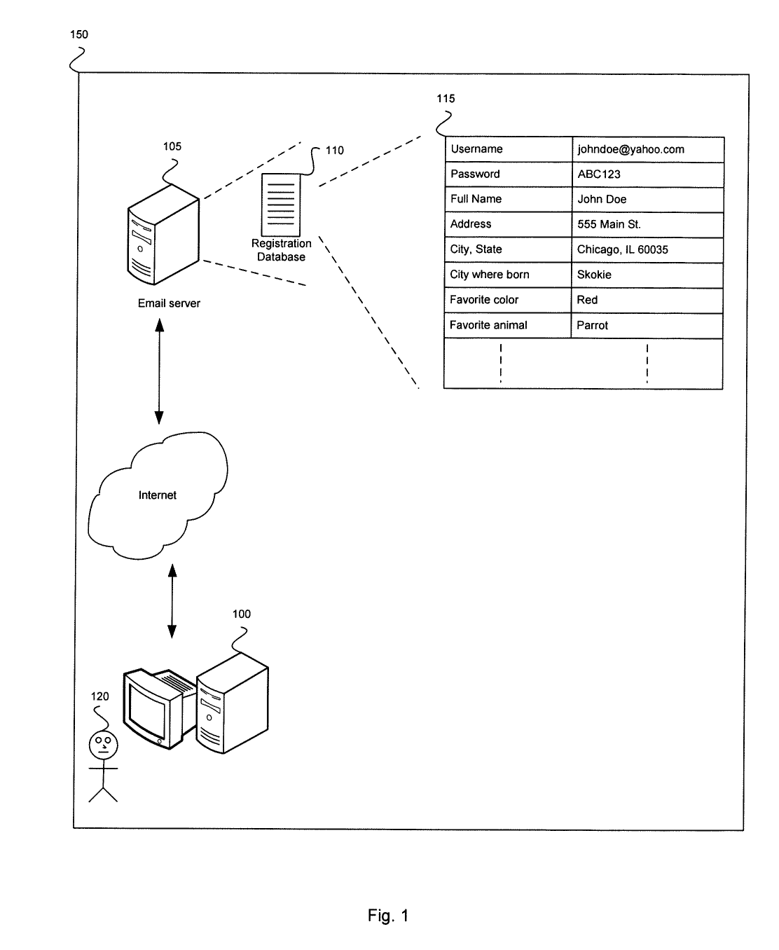

FIG. 1 shows a data communication system 150. In the data communication system 150, a computer user communicates with an email server via the internet connection. Referring to FIG. 1, the system 150 includes a user 120, a user terminal 100, an email server 105, a registration database 110, and registration data 115.

The email server 105 may be utilized to communicate web pages to the computer user 120 via the user terminal 100 that may enable generating a user account for the user 120 on the email server 105, logging into the email server, and creating and reading email messages. The email server 105 may be implemented using any conventional computer or other data processing device. The email server 105 may further be implemented using a specialized data processing device which has been particularly adapted to performing the functions of an email server. These functions include communicating with users operating user terminals such as the user terminal 100, communicating with other networked equipment to transmit and receive email information including email messages and control information, storing and retrieving email messages. Such messages, and such email information may include data defining text, images, video, audio or other information. The email server 105 may include a hardware device, a software application or combinations of the two. The email server 105 may also include timer software and circuitry that may enable determining response times of users.

The registration database 110 may be utilized to store registration data 115 provided by the user 120. The registration data 115 may include information, such as the user's 120 username, password, and address. The registration data 115 may also include personal information about the user 120, such as a favorite color or favorite pet. The registration database 110 may store information about a plurality of registered users. For example, usernames and passwords for a plurality of users may be stored in the registration database 110. In addition, personal information about the users may be stored in the registration database 110. The personal information may include information such as a favorite color or favorite animal. The registration database 110 may reside in any type of memory. For example, the memory may be a solid state memory or a magnetically based memory such as a hard drive.

The user terminal 100 may be implemented using any conventional computer or other data processing device. The user terminal 100 may further be implemented using a specialized data processing device which has been particularly adapted to performing the functions of a user terminal. These functions include communicating with servers, such as the email server 105 or web servers, communicating with other networked equipment to transmit and receive email information including email messages and control information, and storing and retrieving email messages. Such messages, and such email information may include data defining text, images, video, audio or other information. The user terminal 100 may include a hardware device, a software application or combinations of the two.

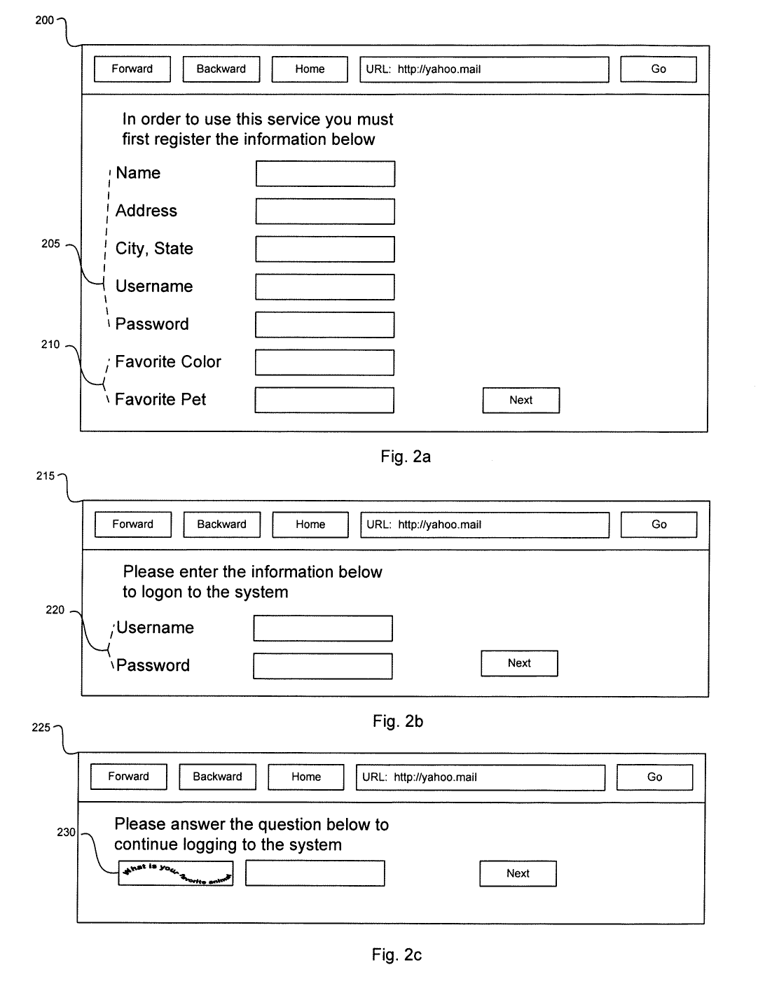

In operation, before being allowed to read and write email messages, the user 120 may be required to generate a user account on the email server 105. For example, the user 120 may navigate to a website operating on an email server 105 offering free email services. The website may have a widget for generating new user accounts. Clicking the widget may cause the email server 105 to communicate to the user 120 a registration web page, such as the registration web page 200 shown in FIG. 2a. This web page may enable the user 120 to specify, for example, basic information 205, such as a name, address, city and state, username, password, and personal information 210, such as a favorite color or favorite pet to be associated with the user account. This information may then be stored in the registration database 110. After registering, the user 120 may then navigate to a first logon screen 215 as shown in FIG. 2b, where the user 120 may be prompted to enter a username and password 220.

After this, the user 120 may then be presented with a second logon screen 225, as shown in FIG. 2c. The second logon screen 225 may include a user challenge, such as a question to be solved. The question may ask the user 120 a question that only the user 120 would know. In this regard, the question may be based on the personal information 210 provided by the user 120 via the registration web page 200. The question may be presented in the form of a CAPTCHA 225. The question presented in the CAPTCHA may be visually distorted in such a way as to make it difficult or even impossible for an automated system to interpret. The user 120 may then be asked to solve the user challenge. Upon providing the correct solution to the question, the user 120 may then be allowed to access other web sites provided on the email server 105, such as those associated with reading and writing email messages. In addition, the user 120 may have to provide the answer within a predetermined time. This may further help determine whether the user 120 is human because a human may be able to answer a question posed more quickly than a computer.

Prompting the user 120 to solve the question and distorting the question may enable determining whether the user 120 is human rather than an automated system. In addition, as the question is based on personal information, the CAPTCHA may not be vulnerable to the relay attacks described above because other humans may not know the answers to the questions presented in the CAPTCHA, the reason for this being that the humans attempting to solve the CAPTCHA will likely not know what personal information utilized to generate the CAPTCHA. For example, although a human at a relay site might be able to read a question, such as “what is your favorite color?”, the same human likely would not know what color was specified as the answer to this question and thus would probably provide an incorrect answer to the question posed in the CAPTCHA. This combination may prevent automated systems and automated systems in combination with human help from generating the email addresses necessary for proliferating spam and other junk mail.

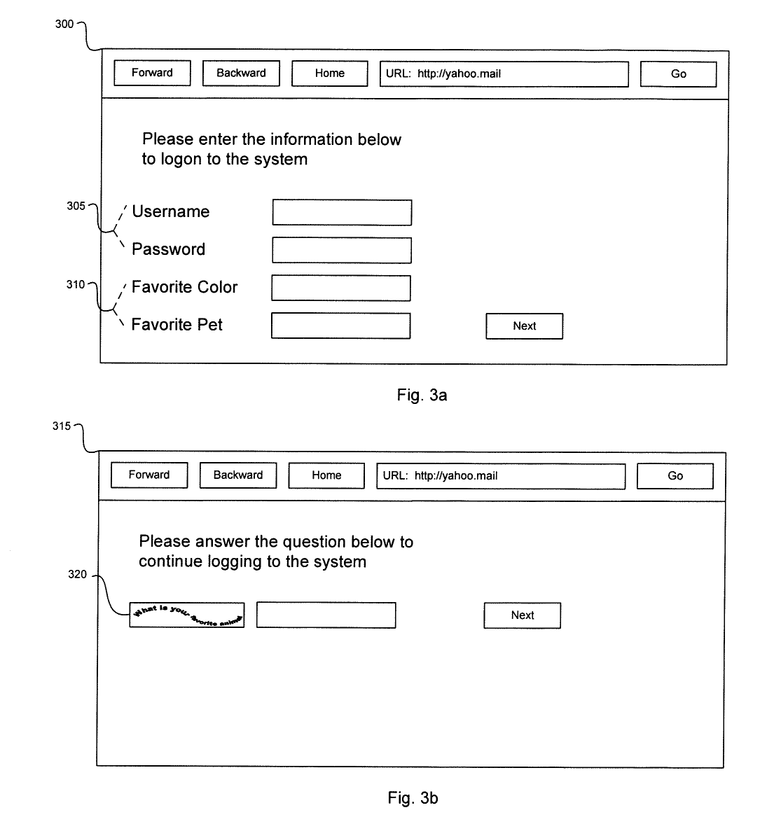

In an alternative embodiment, the user 120 may not be required to register before using the system. In this case, the user 120 may be presented with a first logon screen 300, as shown in FIG. 3a. The first logon screen 300 may prompt the user 120 to enter basic information 305, such as a username and password, and also personal information 310, such as a favorite color or favorite pet. After specifying this information, the user 120 may then be presented with a second logon screen 315, as shown in FIG. 3b. The second logon screen 315 may prompt the user 120 to answer a question presented in a CAPTCHA 320. The question posed in the CAPTCHA 320 may be based on the personal information specified during in the first logon screen 300.

Other embodiments are contemplated as well. For example, protection against automated systems may be enhanced by asking several questions related to several pieces of personal information that may have been provided by the user 120. In addition, personal information may be specified via drop down lists. For example, a drop down list may be utilized to specify a favorite color and limit the number of responses. Images may be utilized as well. For example, images of various animals may be presented to the user 120 to enable the user 120 to specify a favorite animal.

In yet other embodiments, the challenge presented to the user 120 may be based on information collected about the activities of the user 120. For example, the user challenge may be a question, such as “which of the following user ids have you sent/received an email to/from in the last five days?” Then a list of user id choices may be presented to the user 120 where one of the user ids corresponds to a recipient/sender of an email that the user 120 recently sent/received. Another example may be a question that asks the user 120 about recent web pages the user 120 may have visited. For example, the user 120 may be asked a question about an article that may have been on one of the web pages viewed.

In an effort to improve user experience, these sorts of questions may be presented to the user 120 when the email server 105 suspects the user 120 of being an automated system, such as when the user 120 takes too long to answer a CAPTCHA question about personal information or when the user 120 answers too many CAPTCHA questions incorrectly. This may be done so as to not bother an ordinary user who is not suspected of taking part in a spamming operation. These and other methods may further protect against automated systems.

It is to be understood that the advantages described above are not limited to email systems. For example, the system may be adapted to operate with other systems in which a secure communication channel is desired. For example, servers utilized for online banking may generate a CAPTCHA as described above and may communicate the CAPTCHA to a web browser operating on a personal computer. This may enable the banking server to verify the identity of the user of the web browser and may also enable verifying that a human is operating the web browser.

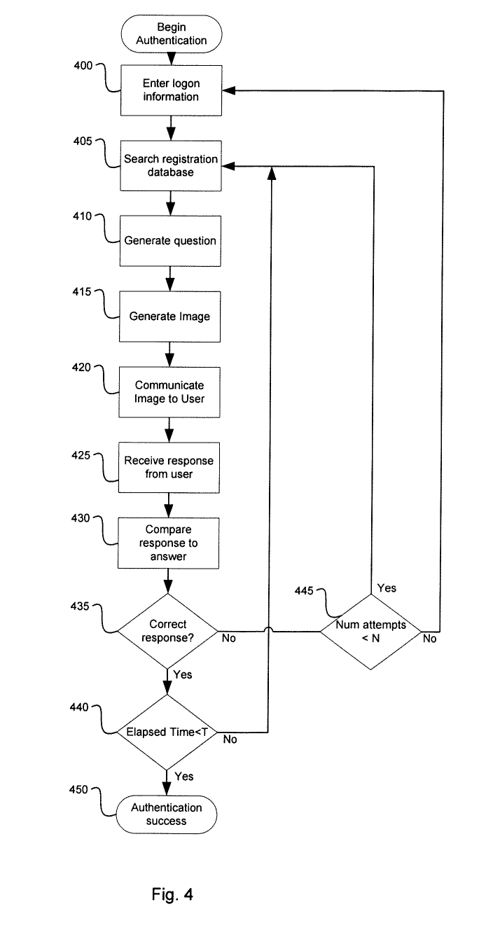

FIG. 4 is a flow diagram for providing a logon screen for verifying that a user is a human in a first embodiment of the invention. At block 400, logon information may be received. For example, the user 120 may provide a username and password via a webpage such as the logon webpage 215 shown in FIG. 2b. At block 405, personal information stored in a database may be selected so as to create a user challenge based on the information. For example, the email server 105 may, for example, randomly select personal information related to the user 120 from the registration database 110 described above. At block 410, a text formatted question based on randomly selected personal information stored in the database may be created. An example of such a text question may be “what is your favorite color?” or “what is your favorite animal?”

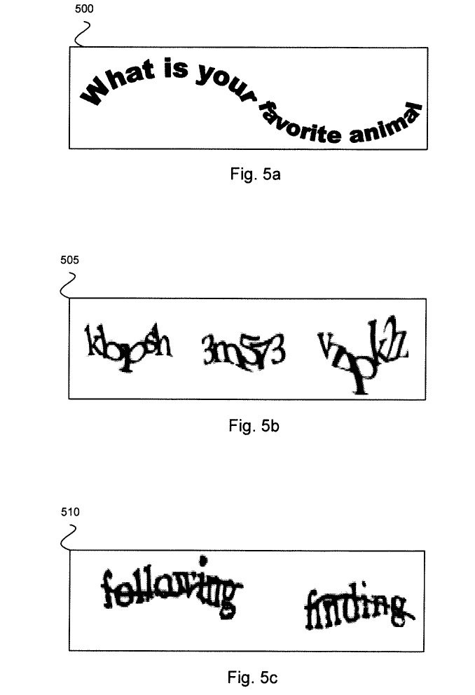

At block 415, the text formatted question may be converted into an image, such as the text image 500 shown in FIG. 5a. As shown FIG. 5a, the text image 500 may be distorted to make it difficult or impossible for an automated system to convert the text image 500 back into a text format. For example, the text image 500 may be warped so as to prevent optical character recognition (OCR) software programs from deciphering the text. There may be numerous other methods to distort the text as well. For example, the text may be distorted as shown in the images 505 and 510 in FIG. 5b and FIG. 5c. In these images 505 and 510, the characters in the text message contact one another. That is, there is no space between them. This may make it difficult to distinguish the individual characters, which may be one the steps required by many OCR programs.

Referring back to FIG. 4, at block 420, the image may be communicated to a user. For example, the image may be presented to the user 120 via the user terminal 100 during the logon process. A timer may be started as well. The timer may be utilized to measure elapsed time between communicating the image to the user and receiving a response. At block 425, a response to the question presented in the image may be provided by the user. For example, in response to the question “what is your favorite animal?” the user 120 may specify “Parrot.” At block 430, the response to the data associated with the text question may be compared to the previously generated question. For example, the mail server 105 described above may verify that the response to the question presented corresponds to the registration data 115 stored in the registration database 110. The timer started above may be stopped so as to measure the elapsed time between communicating the message at block 420 and receiving the response at block 425.

At block 435, if the response matches the registration data then at block 440 then, a computer, such as the email server 105 may determine whether the amount of time that may have elapsed between communicating the image to the user at block 420 and receiving the correct response from the user at block 425 is less than a threshold amount of time. For example, in the present embodiment, the email server 105 may allow for a turn around time of 30 seconds. If the elapsed time is less than the threshold then at block 450 the user may be successfully logged into the system. If the elapsed time is greater that the threshold then the user may be required to re-enter the logon information at block 400. Alternatively, the user may be barred from logging back for a pre-determined amount of time, such as 1 hour. Yet another alternative may be to lock the user out indefinitely until the user contacts service personal associated with the web services he may be trying to gain access to.

Referring back to block 435, if the response is incorrect, then at block 445 the computer may check the number of failed attempts at answering the user challenge. If the number of attempts is below a threshold, then the process may go back to block 405 where a different text formatted question may be generated. If the number of failed attempts exceeds the threshold, then the user may be required to re-enter the logon information at block 400. Alternatively, the user may be barred from logging back for a pre-determined amount of time, such as 1 hour. Yet another alternative may be to lock the user out indefinitely until the user contacts service personal associated with the web services he may be trying to gain access to.

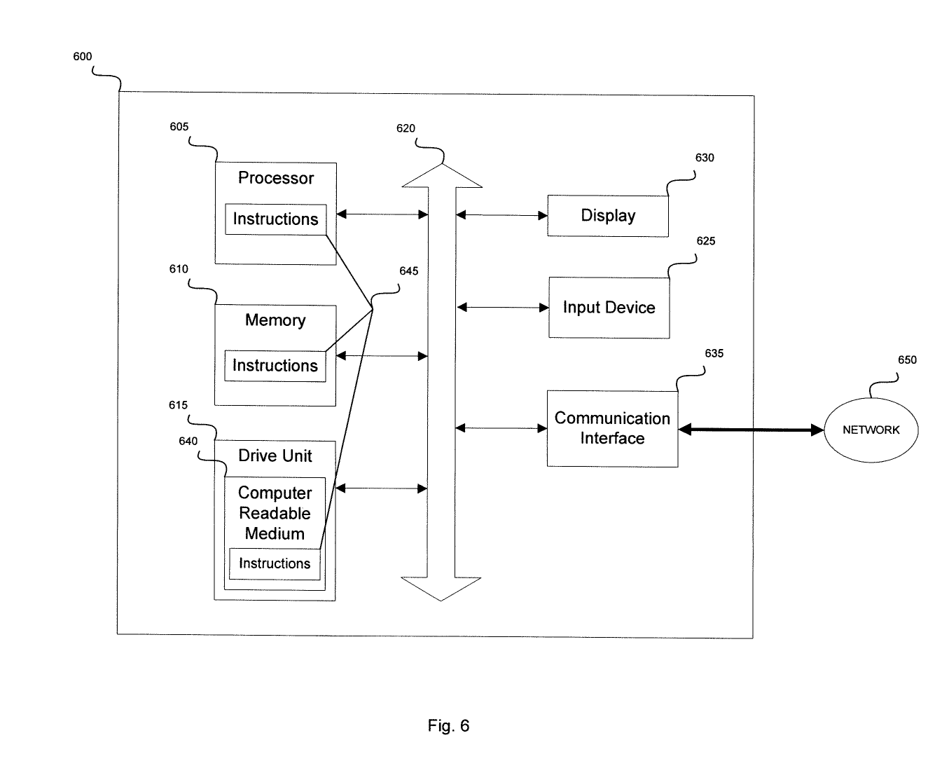

FIG. 6 illustrates a general computer system, which may represent an email server 105, user terminal 100, or any of the other computing devices referenced herein. The computer system 600 may include a set of instructions 645 that may be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 645 (sequential or otherwise) that specify actions to be taken by that machine. In one embodiment, the computer system 600 may be implemented using electronic devices that provide voice, video or data communication. Further, while a single computer system 600 may be illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 605, such as, a central processing unit (CPU), a graphics processing unit (GPU), or both. The processor 605 may be a component in a variety of systems. For example, the processor 605 may be part of a standard personal computer or a workstation. The processor 605 may be one or more general processors, digital signal processors, application specific integrated circuits, field programmable gate arrays, servers, networks, digital circuits, analog circuits, combinations thereof, or other now known or later developed devices for analyzing and processing data. The processor 605 may implement a software program, such as code generated manually (i.e., programmed).

The computer system 600 may include a memory 610 that can communicate via a bus 620. For example, the registration database 110 may be stored in the memory. The memory 610 may be a main memory, a static memory, or a dynamic memory. The memory 610 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 610 may include a cache or random access memory for the processor 605. Alternatively or in addition, the memory 610 may be separate from the processor 605, such as a cache memory of a processor, the system memory, or other memory. The memory 610 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 610 may be operable to store instructions 645 executable by the processor 605. The functions, acts or tasks illustrated in the figures or described herein may be performed by the programmed processor 605 executing the instructions 645 stored in the memory 610. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 600 may further include a display 630, such as a liquid crystal display (LCD), an organic light emitting diode (OLED), a flat panel display, a solid state display, a cathode ray tube (CRT), a projector, a printer or other now known or later developed display device for outputting determined information. The display 630 may act as an interface for the user to see the functioning of the processor 605, or specifically as an interface with the software stored in the memory 610 or in the drive unit 615. In this regard, the display 630 may be utilized to display, for example, whether a business organization is a candidate for transformation. The display 630 may also be utilized to display a transformation plan. In addition, the various reports and surveys described above may be presented on the display 630.

Additionally, the computer system 600 may include an input device 630 configured to allow a user to interact with any of the components of system 600. The input device 625 may be a number pad, a keyboard, or a cursor control device, such as a mouse, or a joystick, touch screen display, remote control or any other device operative to interact with the system 600.

The computer system 600 may also include a disk or optical drive unit 615. The disk drive unit 615 may include a computer-readable medium 640 in which one or more sets of instructions 645, e.g. software, can be embedded. Further, the instructions 645 may perform one or more of the methods or logic as described herein. The instructions 645 may reside completely, or at least partially, within the memory 610 and/or within the processor 605 during execution by the computer system 600. The memory 610 and the processor 605 also may include computer-readable media as discussed above.

The present disclosure contemplates a computer-readable medium 640 that includes instructions 645 or receives and executes instructions 645 responsive to a propagated signal; so that a device connected to a network 650 may communicate voice, video, audio, images or any other data over the network 650. The instructions 645 may be implemented with hardware, software and/or firmware, or any combination thereof. Further, the instructions 645 may be transmitted or received over the network 650 via a communication interface 635. The communication interface 635 may be a part of the processor 605 or may be a separate component. The communication interface 635 may be created in software or may be a physical connection in hardware. The communication interface 635 may be configured to connect with a network 650, external media, the display 630, or any other components in system 600, or combinations thereof. The connection with the network 650 may be a physical connection, such as a wired Ethernet connection or may be established wirelessly as discussed below. Likewise, the additional connections with other components of the system 600 may be physical connections or may be established wirelessly.

The network 650 may include wired networks, wireless networks, or combinations thereof. Information related to business organizations may be provided via the network 650. The wireless network may be a cellular telephone network, an 802.11, 802.16, 802.20, or WiMax network. Further, the network 650 may be a public network, such as the Internet, a private network, such as an intranet, or combinations thereof, and may utilize a variety of networking protocols now available or later developed including, but not limited to TCP/IP based networking protocols.

The computer-readable medium 640 may be a single medium, or the computer-readable medium 640 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 640 may include a solid-state memory such as a memory card or other package that houses one or more non-volatile read-only memories. The computer-readable medium 640 also may be a random access memory or other volatile re-writable memory. Additionally, the computer-readable medium 640 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which included all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

From the foregoing, it may be seen that the embodiments disclosed herein provide an improved approach for verifying that a user is human rather than a computer. Rather than simply relying on prior CAPTCHA methods, which may be circumvented via relay attacks, this approach creates a CAPTCHA question based on randomly selected personal information only known to the user. The addition of personal information to the CAPTCHA renders the CAPTCHA less susceptible to circumvention because, while the humans that take part in the relay attack may be able to read the question, they may not know the answer.

1. A method for determining whether an online service user is human, the method comprising:
collecting information about the online service user;
generating a user challenge based on the collected information;
communicating the user challenge to the online service user; and
receiving a response to the user challenge, wherein a correct response is interpreted to mean that the online service user is human.

2. The method according to claim 1, wherein the user challenge corresponds to a text based question related to the collected information.

3. The method according to claim 2, further comprising converting the text of the text based question into an image and distorting the image so that the image is partially illegible.

4. The method according to claim 3, wherein the text in the image is incapable of being interpreted by a computer.

5. The method according to claim 1, wherein the information corresponds to at least one of: personal information, and information related to an online activity of the online service user.

6. The method according to claim 5, wherein the personal information is stored in a database during a registration process.

7. The method according to claim 1, further comprising determining an amount of time elapsed between communicating the user challenge and receiving the response to the user challenge.

8. A machine-readable storage medium having stored thereon, a computer program comprising at least one code section for determining whether an online service user is human, the at least one code section being executable by a machine for causing the machine to perform acts of:
collecting information about the online service user;
generating a user challenge based on the collected information;
communicating the user challenge to the online service user; and
receiving a response to the user challenge, wherein a correct response is interpreted to mean that the online service user is human.

9. The machine-readable storage medium according to claim 8, wherein the user challenge corresponds to a text based question related to the collected information.

10. The machine-readable storage medium according to claim 9, wherein the at least one code section comprises code that enables converting the text of the text based question into an image and distorting the image so that the image is partially illegible.

11. The machine-readable storage medium according to claim 10, wherein the text in the image is incapable of being interpreted by a computer.

12. The machine-readable storage medium according to claim 8, wherein the information corresponds to at least one of: personal information, and information related to an online activity of the online service user.

13. The machine-readable storage medium according to claim 12, wherein the personal information is stored in a database during a registration process.

14. The machine-readable storage medium according to claim 8, wherein the at least one code section comprises code that enables determining an amount of time elapsed between communicating the user challenge and receiving the response to the user challenge.

15. A system for determining whether an online service user is human, the system comprising:
circuitry that enables collecting information about the online service user;
the circuitry also enables generating a user challenge based on the collected information;
communicating the user challenge to the online service user; and
receiving a response to the user challenge, wherein a correct response is interpreted to mean that the online service user is human.

16. The system according to claim 15, wherein the user challenge corresponds to a text based question related to the collected information.

17. The system according to claim 16, wherein the circuitry enables converting the text of the text based question into an image and distorting the image so that the image is partially illegible.

18. The system according to claim 17, wherein the text in the image is incapable of being interpreted by a computer.

19. The system according to claim 15, wherein the information corresponds to at least one of: personal information, and information related to an online activity of the online service user.

20. The system according to claim 19, wherein the personal information is stored in a database during a registration process.

21. The system according to claim 15, wherein the circuitry enables determining an amount of time elapsed between communicating the user challenge and receiving the response to the user challenge.

22. A method for authenticating a user in a networked environment, the method comprising:
receiving at a first time from the user a username and at least some personal information associated with the user;
storing the username and the personal information in a database;
receiving at a second time the username associated with the user;
retrieving from the database personal information associated with the user;
generating a user challenge based on the retrieved personal information;
communicating the user challenge to the user; and
receiving a response to the user challenge, wherein the user is authenticated when a correct response to the user challenge is received.

23. A method for authenticating a user in a networked environment, the method comprising:
communicating a first logon screen to the user, wherein the first logon screen comprises input fields for specifying a username and personal information;
communicating a second logon screen to the user, wherein the second logon screen comprises a user challenge and an input field for specifying a response to the user challenge; and
receiving the response to the user challenge, wherein the user is authenticated when a correct response to the user challenge is specified.
